(19) United States
(12) Patent Application Publication
(10) Pub. No.: US 2021/0274748 A1
(43) Pub. Date: Sep. 9, 2021

(54) Autonomous Self-Moving Animal Corral System and Device

(71) Applicants: Thomas H. Massie, Garrison, KY (US); Rhonda K. Massie, Garrison, KY (US); Hans D. Høeg, Vancouver, WA (US)

(72) Inventors: Thomas H. Massie, Garrison, KY (US); Rhonda K. Massie, Garrison, KY (US); Hans D. Høeg, Vancouver, WA (US)

(21) Appl. No.: 17/193,677

(22) Filed: Mar. 5, 2021

Related U.S. Application Data
(60) Provisional application No. 62/985,595, filed on Mar. 5, 2020.

(51) Int. Cl. A01K 5/02; A01K 3/00; A01K 7/02; G05B 15/02

(52) U.S. Cl. CPC A01K 5/0291; G05B 15/02; A01K 7/027; A01K 3/00

(57) ABSTRACT

Method, means, and system for a mobile, self-moving, automated animal corral or confinement system.

### CROSS-REFERENCE TO RELATED APPLICATIONS

This disclosure claims the benefit, under 35 U.S.C. § 119(e), of U.S. Provisional Patent Application No. 62/985,595, the contents of which are incorporated herein by reference in their entirety.

### TECHNICAL FIELD

The present invention relates to animal husbandry and rearing, breeding, and raising of animals for meat, fiber, eggs, milk and other food products. It further relates to the responsible, sustainable, and healthy husbandry of animals while protecting them from predators and disease.

### BACKGROUND

The goal with animal husbandry is to rear, breed, and raise animals for meat, fiber, eggs, milk, and other food products. Instrumental to this endeavor is providing animals with sufficient food, water, and shelter, while protecting them from disease and predators.

Growing in importance is achieving the above in a sustainable, humane way, while at the same time producing healthier animals and thus healthier and more organic food products. Many animals benefit from being raised in the pasture, among others, cows, pigs, and chickens. Using chicken as an example, pastured chickens are by definition birds that live outside in a natural habitat (on grass, in the fresh air and sunshine with space to roam and forage). Rotating chickens to fresh pasture regularly, brings about healthier birds and also regenerates soils and grasslands, which is arguably not only sustainable, but goes even further. There are many designations for chickens today, pasture-raised, free range, cage free, local, organic, humane, biodynamic, sustainable, regenerative. A century ago, this is how chicken was raised. Pasture raised chicken is very different from today's industrial chicken. In the pasture industry “always outside” refers to chickens living on pasture full-time. Pasture birds eat bugs, worms, grasses, seeds, and more, and are kept healthy by sunshine, fresh air, and space instead of antibiotics. Also, pasture farms are out in the open for all to see. Also, healthy fresh grass and bugs are key to producing high quality eggs, meat, or milk. Many poultry farmers for example refuse to raise chickens on dirt, and go to laborious expensive lengths to provide grass fed pastured chickens. But providing a constant supply of fresh grass and bugs is expensive and laborious, and thus in many cases practically impossible for stationary enclosures.

Another substantial challenge with raising animals is protecting them from predators is a challenging problem. Typically, it is solved by providing a type of enclosure such as a corral or coop to keep the animals safe from hawks, vultures, coyotes, dogs, weasels, raccoons etc. One problem with enclosures however is crowding of animals. It is expensive to provide generous space for each animal, and this has led to a series of regulations, for example that the label “organic eggs” requires at least two square feet per chicken. Disease can quickly spread among animals confined to tight quarters, one of the reasons many animals are fed antibiotics, which has a number of downsides, and enclosures quickly become messy and toxic with animal excrement and need to be cleaned regularly. Cleaning enclosures is a time-consuming and unpleasant process, and one of the reasons people give up on animal husbandry.

One solution which merges the goal of achieving pastured animals while at the same time keeping them safe from predators is to use mobile corrals, mobile chicken coops for example, which are typically called chicken tractors. A mobile chicken tractor is a coop or cage constructed such that it can be moved manually. Typically, this involves the operator lifting one end of the coop and rolling it on a set of wheels to a new location with fresh grass. An example of mass deployment of mobile chicken tractors can be found at Polyface Farms in Virginia, run by Joel Salatin. This solution addresses the problem of waste piling up in the coop and so obviates the need to clean the coop, and it also provides fresh grass and bugs for the chickens.

However, mobile corrals introduce a new problem, which is that the operator regularly has to move them, which is laborious and disruptive, and in Salatin's case requires numerous farmhands. Not only does it require substantial manual labor, but it also requires keeping track of when to move the corrals, and interrupting other farm processes or work to move the corrals.

To solve these problems, there have been several attempts at building self-moving corrals. These motorized systems however have a number of drawbacks:
Unless they are hooked up to a tractor or other type of pulling vehicle, which is expensive and time-consuming, they are based on driven wheels and therefore easily get stuck in varying terrain. The corrals have to have an open bottom in order to allow access to grass, which means that the walls of the corral have to be as low to the ground as possible to keep predators out. This causes the corrals to get stuck, and at times they can even get high-centered, where the wheels end up without ground contact.
The weight, size, complexity, and cost of many self-moving corrals do not work for budget farmers and small scale producers, or for families simply interested in producing their own food.
Mobile corrals generally have insufficient water systems, with no good way of collecting rain water, channeling it to an onboard storage container, and dispensing the water to the animals. Having to regularly bring water to the corrals defeats much of the purpose of self-movement—once a farmer has to make a trip out to the corral in the field with water, she might as well move it as well.
Self-moving corrals risk injuring animals during movement because animals can get limbs caught in the corral as it moves, or even get run over by it.
Mobile corrals in general do not have active protection systems such as electric fences, which are generally designed to be stationary.

The aforementioned problems notwithstanding, if it is possible to develop a system which reduces the labor associated with pastured animal husbandry, there are substantial financial gains to be had. In the case of raising broilers for example, production labor can account for more than 20% of the total cost. It is estimated that a chicken tractor which autonomously moves, feeds, waters, and protects birds from predators could reduce this labor cost by more than 50 percent. With net profits from raising pastured birds ranging from around 3-20%, depending on type of bird and raising standard (pastured, non-GMO pastured, organic, etc.) such a cost reduction could improve profits substantially. By certain industry metrics, a unit reduction in labor cost could lead to a five to tenfold increase in enterprise value.

Therefore, the present invention provides methods and systems for sustainable, environmental, safe, healthy, disease-free animal husbandry while yielding better food products and reducing labor costs. Specifically, it provides users with an automated corral—or ways to achieve such—that requires minimal cleaning or maintenance, helps fertilize the ground, moves itself, auto-feeds, auto-waters, does not get stuck, and is lightweight.

### SUMMARY

Autonomous self-moving animal corral system and device.

In one aspect of the disclosure, an autonomous self-moving animal containment system is provided having one or more of the following: a containment device for containing animals; a solar panel for collecting energy; a capacitor for storing energy; an actuator for moving said containment device (because of easily getting stuck in terrain, wheels are not universally effective/robust, so movement should be achieved either by a pull-cable or by using radially asymmetric ground contact members, like arms, flippers, or even square wheels, which provide a slight vertical lift in the process of horizontal forward propulsion); a water collection and storage device; a feed dispenser (passive for egg birds; actuated for meat birds, who will eat themselves to death if given unlimited access to feed); a perimeter shocker/electric fence to protect animals from predators; a communication module for wireless communication with a remote device such as smartphone or computer for interacting with the containment system remotely; and an electronic control unit for managing the operation of the system.

In another aspect of the disclosure, an autonomous self-moving animal containment system may be additionally provided having one or more of the following: a second capacitor (for more energy storage and/or boosting perimeter shocking power); anti-scalp wheels to make the containment device easier to move, especially laterally and rotationally; a liftable hood with dampers for accessing the interior of said containment device. a water level sensor to keep track of the amount of stored water; a heater to keep stored water from freezing; a series of water dispensing nipples at different heights to accommodate different size animals; a clean-out access point for the water storage device; a feed level sensor to keep track of amount of feed; a camera for viewing interior of said containment device; and an inducer/persuader to induce animals to move forward with the movement of the containment device (necessary when using the lift form of locomotion to make sure animals are not injured).

In another aspect of the disclosure, an autonomous self-moving animal containment system may be provided as further having one or more of the following, wherein: automatic feeding could be coordinated with movement of system to avoid additional actuator or/and to provide feed to pull birds away from moving walls when the system is moving; containment device is moved slowly or in increments small enough (not larger than the size of an animal) to not harm animals; movement of containment device is keyed off of daylight using solar panel both as a light sensor in addition to energy collector; and in order to boost the electrical shock, the energy of one capacitor is intermittently transferred to a second capacitor using an inductor to achieve a higher voltage potential in the second capacitor before energizing an electrical coil to produce the shock.

In another aspect of the disclosure, an autonomous self-moving animal containment system may be provided as having one or more of: a containment device (e.g., corral/cage structure); an energy collection device (e.g., solar panel(s)); an energy storage device (e.g.,: capacitor(s) (could technically do without this but it would not work well on cloudy days)); a movement device for moving the system (e.g., motor for pulling cable or actuating member(s) for lift-and-translate type gait); and an electronic control device for managing system operation (e.g., integrated circuit with microprocessing capabilities).

In another aspect of the disclosure, an autonomous self-moving animal containment system may be additionally provided having one or more of the following: non-maiming system (e.g., 1. either moving in such a way that does not injure animals, either in very small increments or very slowly; 2. feeding in conjunction with move to attract animals away from moving walls; 3. employing a compliant member at back of system which gives/yields in case of contact with animals; 4. incorporating an element designed to physically “persuade” animals to move away from a moving wall when the system moves, such as feed or an alarm/alert; water collection, storage, and dispensing system (e.g., using roof with gutters as a collection surface connected to a storage container); feed storage and dispensing system (e.g., arranged away from back of system, either passive (egg birds) or active (fixed amounts of feed dispensed each time)); animal protection system (e.g., an electric fence/shocker wire(s) around the perimeter of the system); and wireless communication system (e.g., Bluetooth module for connection to a personal digital device; could also be an internet connectivity module).

In another aspect of the disclosure, an autonomous self-moving animal containment system may be additionally provided having one or more of the following: wherein said movement device comprises using a cable to pull said containment device; wherein said movement device comprises a radially asymmetric rotating element(s) which lifts said containment device vertically in the process of providing forward horizontal motion relative to the ground.

In another aspect of the disclosure, an autonomous self-moving animal containment system may be provided with a non-maiming system as discussed herein, and one or more of the following: the non-maiming system includes moving said containment device slowly enough to not injure animals during movement; the non-maiming system includes movement of said containment device that is so small (generally not bigger than the size of an animal) as to not injure animals during movement; the non-maiming system includes an element which can deflect if in contact with animals during motion of containment devices so as to not injure animals; the non-maiming system includes an element which induces/persuades animals to move forward with the movement of the containment device; and when provided with a feed storage and dispensing system, the non-maiming system includes dispensing feed towards the front of the animal containment device such that the animals move towards the front of the device and are not injured by the back of the containment device during movement.

In another aspect of the disclosure, an autonomous self-moving animal containment system may be provided with a water collection storage, and dispensing system as discussed herein, and one or more of the following: the water collection and storage system includes a sensor for sensing water level; the water collection and storage system includes a heating system for keeping water in liquid state during cold weather; the water collection and storage system includes a water dispensing system arranged at different heights to accommodate different size animals; and the water collection and storage system includes a cleanout system.

In another aspect of the disclosure, an autonomous self-moving animal containment system may be provided with feed storage and dispensing system as discussed herein, and one or more of the following: the feeding system includes a sensor for sensing feed level; wherein feed is automatically dispensed over a time period; and wherein feed is automatically dispensed in a certain amount.

In another aspect of the disclosure, an autonomous self-moving animal containment system may be provided with an animal protection system as discussed herein, and one or more of the following: the animal protection system includes a system for providing an electric shock; the animal protection system includes a system for providing an electric shock wherein the energy storage system comprises at least two elements wherein the energy of the first element is intermittently transferred to the second element using an inductor to achieve a higher voltage potential in the second capacitor before energizing an electrical coil to produce the shock; the animal protection system uses the containment device as electrical ground; and the animal protection system is automatically powered down when it detects a user in a certain proximity of system.

In another aspect of the disclosure, an autonomous self-moving animal containment system may be provided with a wireless communication system as discussed herein, and one or more of the following: the wireless communication system can be used to interact with the system from a digital device such as a smartphone or a computer, also through onboard sensors or a camera.

In another aspect of the invention an autonomous self-moving animal containment system may be provided with the structure discussed herein for at least one or more of: containing animals; collecting energy; storing energy; moving the system; and electronically operating the system; not injuring animals when moving the system; collecting, storing, and dispensing water to animals; feeding animals; protecting animals from predators; wirelessly communicating with system.

In another aspect of the invention, an electronic system for controlling a mobile animal corral may be provided as being capable of at least one or more of the following: storing energy; directing stored energy to actuate an actuator to move the corral in such a way that corralled animals are not injured; directing stored energy to administer shocks to predators attempting to access corralled animals; directing stored energy to administer feed to corralled animals; communicating wirelessly with remote digital devices; communicating with sensors configured on mobile corral.

In another aspect of the invention, a system for moving at least one animal corral without injuring animals may be provided having one or more of the following: a solar panel for energy collection; a capacitor for energy storage; a pull-cable system (like a winch) for attaching to said corral(s); an actuator for actuating pull-cable; and an electronic control unit for managing system. A system for connecting additional corrals to said pull-cable system in order to move multiple corrals simultaneously/at generally the same time/in the same operation may also be optionally provided with one or more of the above. Said actuator may also be optionally controlled so as to pull the corral(s) in such a way as to not injure animals (either very slowly, or in increments so small (typically less than the size of animal) animals cannot be injured by the moving corral(s)).

In another aspect of the invention, a system for moving one or more animal corrals without injuring animals may be provided having one or more of the following: a solar panel for energy collection; a capacitor for energy storage; a pull-cable system (like a winch) for attaching to said corral(s); an actuator for actuating pull-cable; and an electronic control unit for managing solar panel, capacitor, and an actuator. A structure that can be rigidly mounted, for example to the ground, in order to provide a bracing force sufficient to pull said corral with actuator, may also be optionally provided with one or more of the above.

In another aspect of the invention, an animal corral system may be provided having one or more of the following: an animal containment structure; a water system for collecting, storing, and dispensing water; anti-scalping wheels to simplify manual movement of said system (or some kind of couple-curvature skis or cups which can slide in all directions); a feeder; a liftable hood/roof with force assist; a flapper/persuader; a winch, either powered or manual, mounted on either the corral or remotely, power could come from energy storage device or directly from grid, manual crank or push-button operation; a pull bar for pulling multiple corrals.

In another aspect of the invention, an animal corral system may be provided having one or more of the following: a corral; a winch; wherein the which is manual (e.g., with a crank); wherein winch is actuated (e.g., with a motor); wherein the winch is actuated off of a timer; wherein the winch is actuated by grid power; wherein the winch is actuated by local stored energy; wherein there is a mechanism for connecting multiple corrals to winch cable; wherein a water storage and dispensing system is on said corral; wherein a water collection, storage, and dispensing system is on said corral; and wherein omnidirectional cups/skis/wheels are on said corral.

In another aspect of the invention, an electrical system for protecting animals in a mobile corral against predators may be provided having one or more of the following: an energy collection system (e.g., solar panel(s)); an energy storage system; (e.g., capacitor(s)); an electrically conductive element attached to said corral and energized to an electrical potential relative to the ground so as to deliver an electrical shock to anything coming into contact with said element while also in contact with the ground or said corral (e.g., an electrically conductive element like a wire); an electronics unit for administering energy to said electrically conductive element; wherein the shocker auto-shuts off/element is auto de-energized when a user approaches (detected via, e.g., a fob or mobile phone); wherein energy is shifted within energy storage system (shifted between capacitors) in order to boost power to the electrically conductive element; and wherein said electrical system is electrically grounded to said corral.

In another aspect of the present disclosure, an application program for controlling a remote animal corral may be provided, running on a programmable device, allowing a user through a graphical user interface to wirelessly perform one or more of the following: actuate an actuator to move the corral; control electrical energy to administer electrical shocks to the environment; actuate an actuator to dispense feed to animals in the corral; access a camera to view the interior of the corral; check the status of the corral, like position, energy level, water level, feed level, motion history, faults, or problems; adjust the settings of the corral; and download and upload data from the corral.

### BRIEF DESCRIPTION OF THE DRAWINGS

FIGS. 1A and 1B show the preferred embodiment of the present invention.

FIGS. 2A and 2B show additional features of the preferred embodiment of the present invention.

FIGS. 3A and 3B show the energy and water collection systems of the present invention.

FIGS. 4A and 4B illustrate water collection, drainage, and storage system.

FIGS. 5A and 5B show a prototype in use with animals.

FIG. 6 shows a schematic overview of the main elements of the present invention.

FIG. 7 shows a schematic overview of the main elements of the electronic and electrical systems of the present invention.

FIG. 8 shows the paddle type elements required for the paddle type gait.

FIGS. 9A-9D show how the paddle gait works.

FIGS. 10A and 10B show two different variants of mechanical non-maiming devices.

FIGS. 11A and 11B show two different electric fence implementations.

FIG. 12 shows the graphical user interface (GUI) for wirelessly interacting with the system through a smartphone or remote digital device.

FIGS. 13A-13C, show an alternative implementation wherein the electrical and electronic systems reside off the corral itself and a winch can be used to pull one or more corrals simultaneously.

### DETAILED DESCRIPTION

The following description illustrates the invention by way of example, not by way of limitation of the principles of the invention. This description will enable one skilled in the art to make and use the invention, and describes several embodiments, adaptations, variations, alternatives and uses of the invention, including what we presently believe is the best mode of carrying out the invention.

Prior art. The prior art covers a series of solutions intended to provide self-propelled animal shelters. One is to simply hitch one or more passive animal containment assemblies to a moving tractor, as done at Crown S Ranch, in Twisp, Wash. in 2010 (https://www.youtube.com/watch?v=qnCX53JVWCY). Another example is the work of students at Oregon State University in 2012, who attempted to build a self-moving coop (http://blogs.oregonstate.edu/engineering/2012/06/06/automated-mobile-chicken-coop/). It is not clear that this solution was ever reduced to practice. Similarly, the Full Monty Chicken Coop of 2011 describes a self-moving coop (https://inhabitat.com/tag/full-monty-chicken-coop/, and https://earthtechling.com/2011/09/a-solar-powered-chicken-coop-for-dummies/, https://www.greenlaunches.com/alternative-energy/backyard-solarpowered-chicken-coop-propels-self-with-green-energy-keeps-hungry-chickens-active.php), but it does not appear that this was ever reduced to practice either. One of the earliest examples of a patent in this area is U.S. Pat. No. 4,048,959A (1976), by Steele. This disclosure teaches a mobile, portable, and self-propelled corral for penning animals. This invention relies on driven wheels and a steering means. In U.S. Pat. No. 4,3411,81A (1981), “Livestock confinement pasture machine,” Fair also teaches driven wheels and a steering unit. Humblet also teaches wheels driven by an electric motor in BE1010748A6 (1996). Badiou teaches a Mobile Animal Shelter Device in WO2017197494A1 (2016) wherein a controller drives one or more motors operatively connected to (transport) wheels.

Additional prior art reference list:
Daniel Badiou, Mobile Animal Shelter Device, 2016
Andre-Marie Humblet, Movable cage for domestic animals e.g. rabbits, 1994
Walter R Fair, Livestock confinement pasture machine, U.S. Pat. No. 4,341,181A, 1982
Battery Free Outdoors, LLC, including U.S. Pat. No. 8,525,469B1 to Laceky (remote capacitor powered camera), and U.S. Pat. No. 7,275,501 B1 to Lackey (remote capacitor based auto-feeder—it teaches use of first and second capacitive networks, whereas the present invention only uses a single capacitive network.)
Solar powered chicken tractor at Crown S Ranch, Twisp Wash., 2010, https://www.youtube.com/watch?v=qnCX53JVWCY
Oregon State University student project, 2012, http://blogs.oregonstate.edu/engineering/2012/06/06/automated-mobile-chicken-coop/
Full Monty Mobile Chicken Coop, 2011, https://inhabitat.com/tag/full-monty-chicken-coop/, https://earthtechling.com/2011/09/a-solar-powered-chicken-coop-for-dummies/, https://www.greenlaunches.com/alternative-energy/backyard-solarpowered-chicken-coop-propels-self-with-green-energy-keeps-hungry-chickens-active.php

Websites related to the prior art:
Front yard coop: a solar-powered and self-propelling chicken coop, inhabitat.com
Hersh mobile chicken coop with chicken run, wayfair.com
Betterchickenhomes.com
Omlet Eglu Cube Chicken Coop
https://mobilechickenhouse.com
https://pasturedpoultrytalk.com/tag/terrell-spencer/
Smoky Mountain Chicken tractors, smokymtnchickentractors.com
Urbancoopcompany.com
Rules for raising chickens: https://www.dummies.com/home-garden/hobby-farming/raising-chickens/how-to-determine-your-flock-size-and-space-requirements/
https://nichehacks.com/niche-hack-report-backyard-chickens-niche/
https://ecopetlife.com/chickens-eating-dog-poop/

### Embodiment

In the context of its basic method, the present invention's most basic embodiment is a self-propelled animal shelter device.

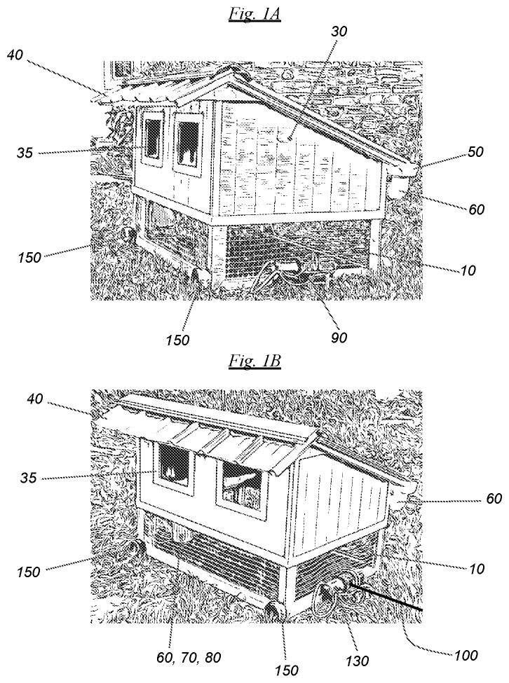

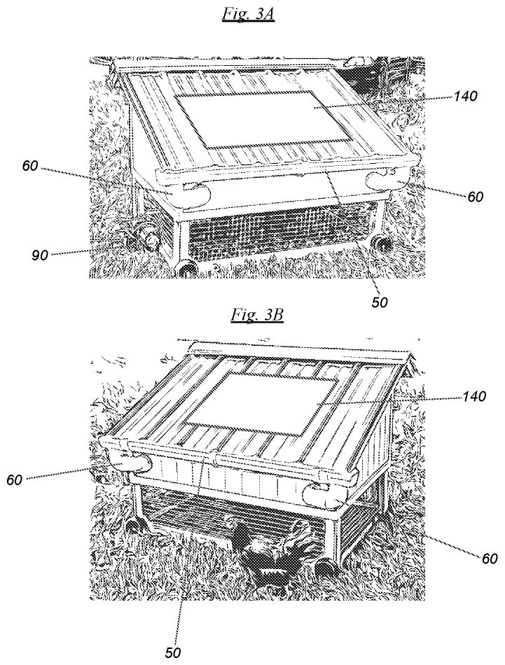

The preferred embodiment of the present invention will be described by way of an example wherein a chicken coop is the animal containment device in question. Referring now to the drawings, in which like reference numbers represent similar or identical structures throughout, FIGS. 1A and 1B show the basic device. Netting 10 makes up the lower portion of the sidewalls 30 which include windows 35. A hinged roof 40 covers the structure. A gutter 50 for collection of rainwater is connected to a piped water storage system 60 with a termination 70 comprising a nipple dispenser 80 for releasing water to the animals. A cable winch 90 with cable 100 is mounted to the bottom rim of the device. The winch 90 is driven by an actuator 130. When the cable 100 is coupled to an external post or anchor (not shown) the actuator 130 moves the assembly by turning the winch 90, thus winding up the cable and pulling the device gradually closer to the anchor. A solar panel 140 (seen in FIGS. 3A, 3B) is coupled to a capacitive energy storage unit (not shown) which in turn provides power to an electronic control unit (not shown) which controls the actuator 130. Anti-scalp wheels 150 reduce friction between the device and the ground and make it easier for the actuator to pull the device via the winch 90. Crucially, the wheels 150 have dual-axis curvature and are curved in the sideways direction (anti-scalping, as on motorized lawn mowers) as well as the forward direction to make it easier to slide or rotate the device sideways if it should become necessary to change direction (it is very difficult to change the direction of traditional chicken tractors with traditional wheels with singular curvature).

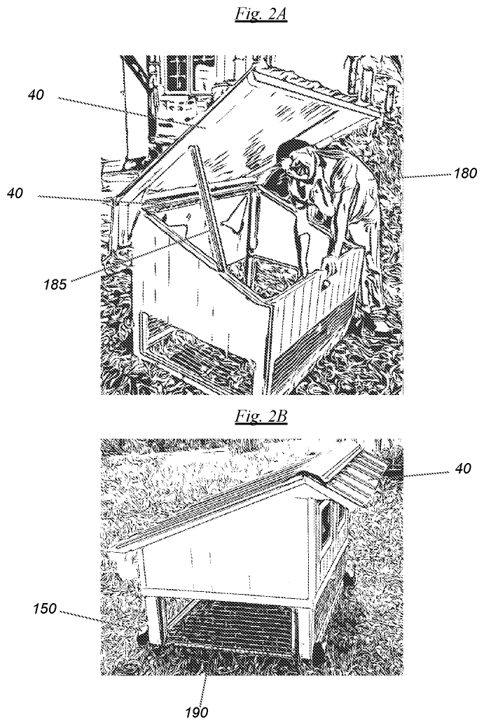

FIG. 2A shows the hinged roof 40 which allows a congressman 180 to access the inside of the device, for example to refill feed, interact with the animals, or collect eggs. There are also egg boxes (not shown), a roosting bar (not shown), and a hydraulic/pneumatic strut 185 to allow for soft opening and closing, fixed positioning, and force-assisted lifts. FIG. 2B shows a spring loaded flapper door 190 at the back of the device keeps the animals from being harmed when the device moves. It flexes when necessary but at the same time is configured to make it difficult for predators to open. An automated feeder (not shown) is located at the front of the device and dispenses feed right before the device moves so the chickens flock to the feed at the front and move away from the moving butt end of the device.

FIGS. 3A and 3B show the system's energy and water collection systems. A solar panel 140 converts sunlight to electricity which is used to charge an energy storage device (not shown), in this case one or more capacitors. The gutter system 50 collects rainwater running off the roof 40 and the solar panel 140. The water drains to a storage tube system 60 on either side of the gutter system 50.

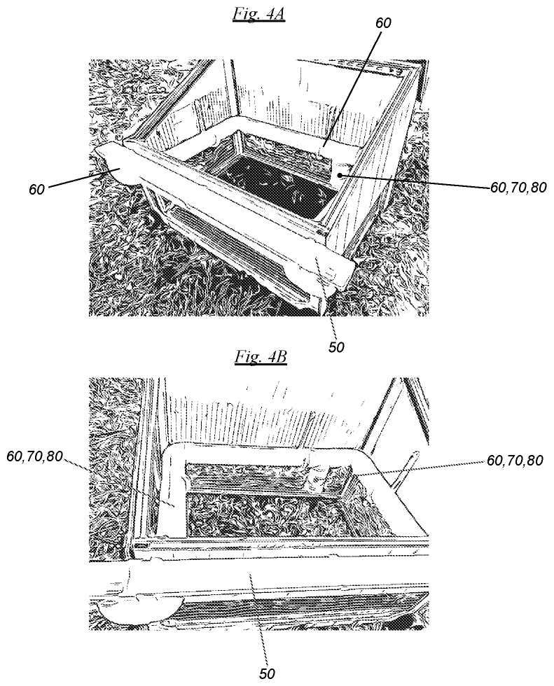

The water storage tubes 60 connected to the gutter system 50 run along the inside of the containment device and meet in a termination tube 70, as shown in FIGS. 4A and 4B. The termination tube is outfitted with a nipple dispenser/valve (not shown) for dispensing water to the contained animals.

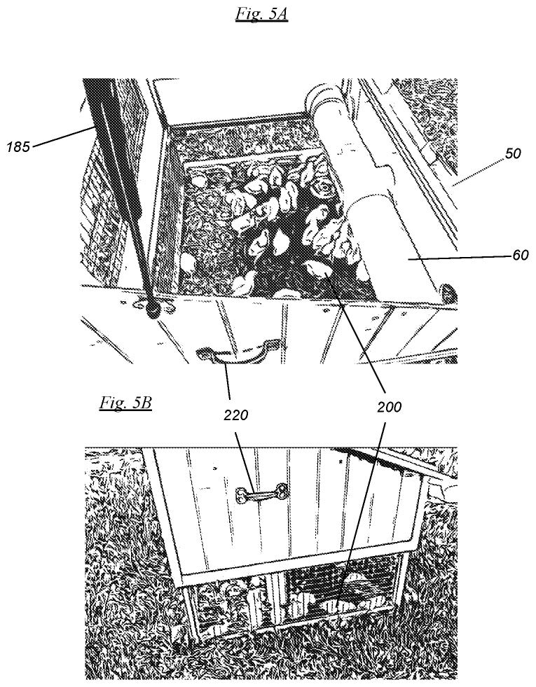

FIG. 5A shows the inside of the preferred embodiment in use, housing baby chicks 200. Also visible is the water storage tank 60, and the pneumatic strut 185 connected to the liftable roof (not shown), again for providing damped closing and force-assisted lifting. FIG. 5B shows the device in use from a different angle and also shows the handle 220 which allows a user to easily move the corral or adjust its direction manually, in part thanks to the anti-scalp wheels which are curved both in the forward and transverse directions.

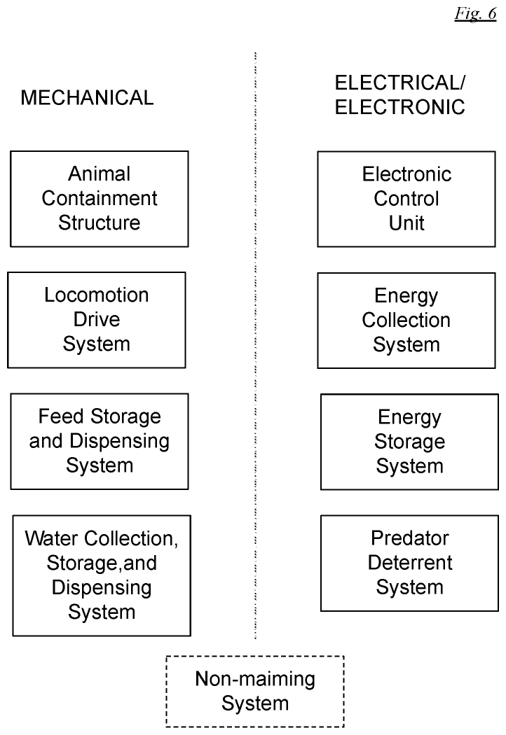

FIG. 6 provides an overview of the main conceptual components of the preferred embodiment. There are generally speaking eight to nine basic subsystems, which can be loosely categorized as mechanical or electrical/electronic, although there is obviously overlap between many of the systems. The non-maiming system can be either purely mechanical or purely electronic in that it can either consist of physical elements which protect corralled animals from injury when the corral is moving, or it can be purely electronic in that it is simply an electronically controlled motion scheme which moves either so slowly or in such small steps that animals would not be injured even if they were to make contact with the corral walls during movement.

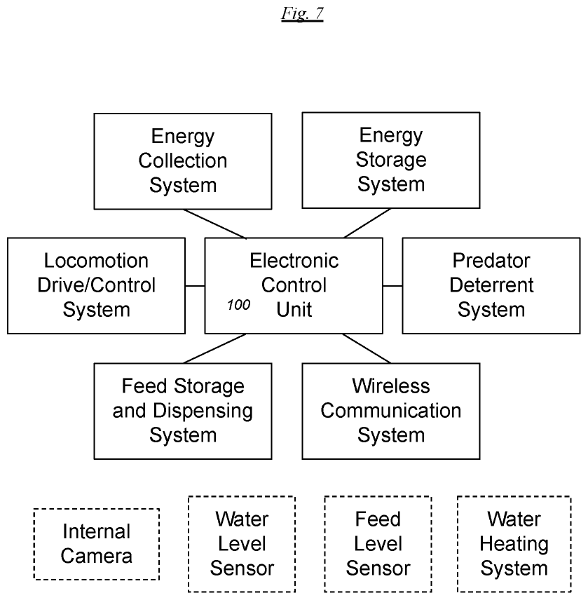

FIG. 7 shows a similar overview of the electrical and electronic systems of the preferred embodiment, with the electronic control unit (ECU) as the central intelligence or “brain” of the system. The ECU uses pulse width modulation (PWM) to reduce the average current and voltage delivered to the winch or other drive motor (not shown in this figure). Additional electronic elements such as a camera for monitoring corralled animals, and a series of sensors for monitoring conditions in the corral can be added.

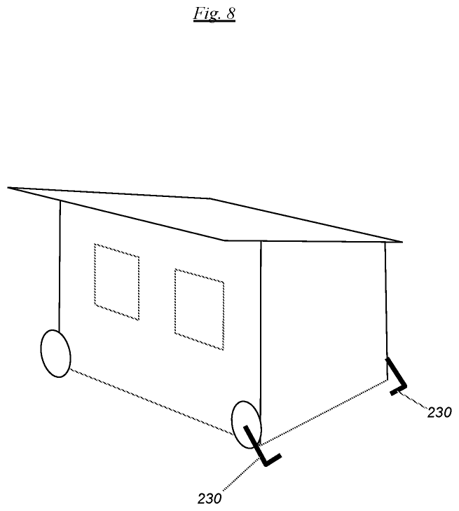

FIG. 8 illustrates an alternative movement system to using a winch. Instead of using driven wheels, which can easily get stuck in difficult terrain, and instead of using a winch, which can be inconvenient in certain circumstances, the displayed movement system uses a set of rotating paddles 230 which is capable of pulling the corral forward almost irrespective of the underlying terrain.

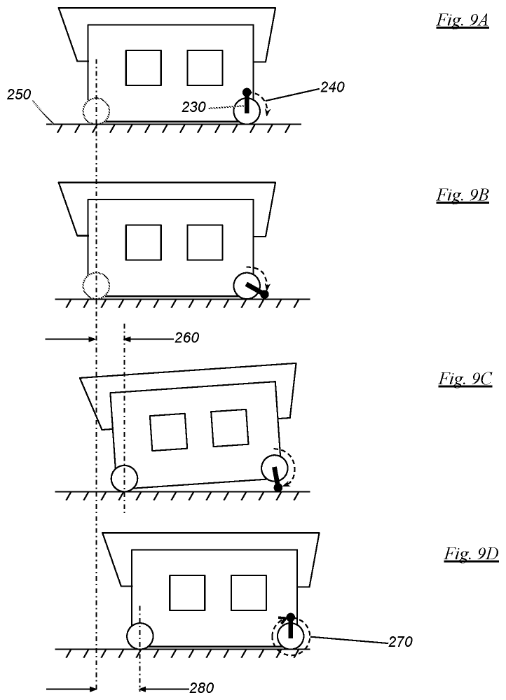

The gait is illustrated in FIGS. 9A-9D. When the paddles 230 rotate in a circular path 240 (FIG. 9A), they eventually contact the ground 250 (FIG. 9B), at which point they cause the corral to lift slightly off the ground 250 and then drive the corral forward 260 (FIG. 9C). After a full rotation 270 the paddles 230 return to their starting position, and the corral has moved forward by a distance 280.

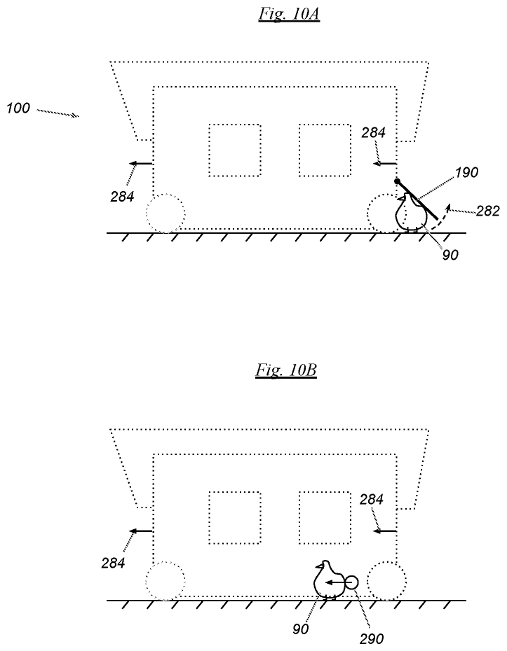

FIGS. 10A and 10B illustrate two non-maiming devices. The first, shown in 10A, is a hinged element 190 reminiscent of a hanging flap which swings open 282 if an animal 90 comes in contact with it as the back wall of the corral moves towards them during forward motion 284. By swinging open the flap 190 reduces the contact force with the animals and also prevents animals from getting trapped under or caught in the moving wall. The second device, shown in 10B, can be a padded or flexible transverse bar 290 located such that it cannot injure the animals but rather induces or persuades them to move forward with the moving corral.

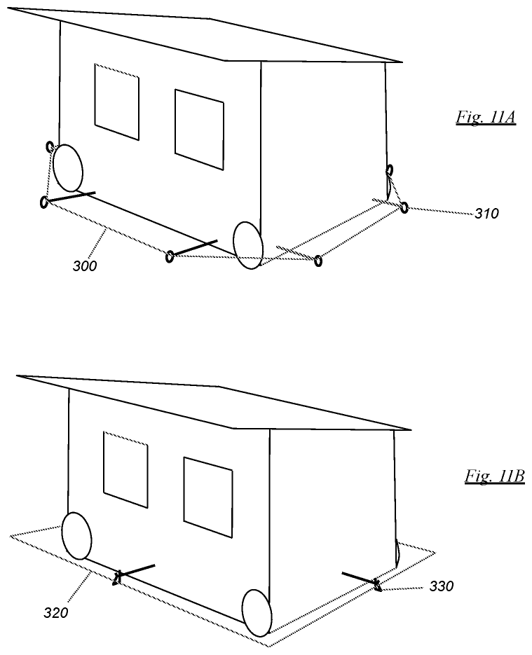

FIGS. 11A and 11B show the predator deterrent system. In its simplest form it is a mobile electric fence where an electrified wire 300 via struts 310 is mounted to the frame of the corral around its perimeter. The wire 300 is located at a height to make it hard for approaching predators to avoid. The fence system is grounded to the corral and so is not permanently anchored to the ground 250, which would reduce mobility. However, since the corral sits very close to the ground for the purposes of making it hard for predators to reach underneath, grounding to the corral is effectively the same as grounding to actual ground, which is what makes the shocking system possible—it is necessary to avoid a difference of electrical potential between the ground and the corral frame so as not to injure or kill animals. In winched systems it would be possible to use the winch cable or the post or structure to which the cable attaches as the electrical ground, as either has good ground contact. An alternative embodiment is shown in FIG. 11B where the wire 300 is replaced by a rigid loop 320 which can keep its own shape and so instead of being strung can simply be inserted in the holders 330. It is also possible that a mobile electric perimeter scheme as the one discussed above could be used alone to contain animals such as livestock without the need for hefty or rigid corral frames.

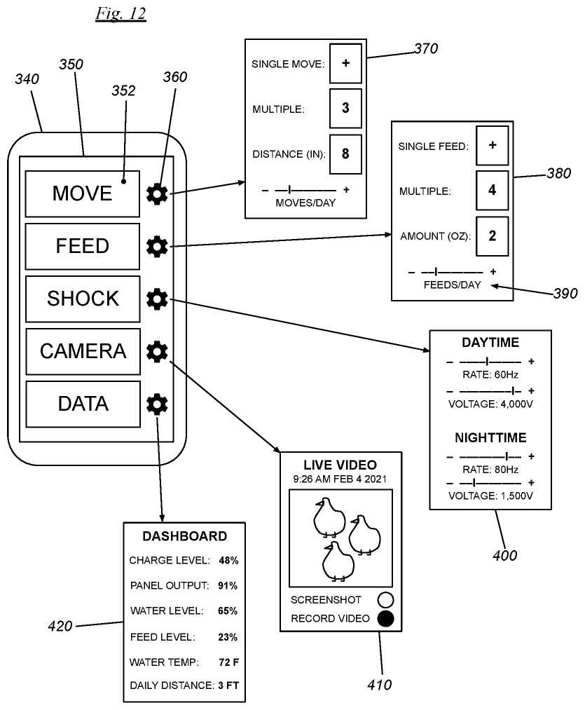

A key component of this invention is the ability for a user to interact with the autonomous corral wirelessly through a digital device. FIG. 12 shows the graphical user interface (GUI) as displayed on a smartphone 340. In its simplest form the GUI allows the user five basic direct actions from the homescreen 350 through buttons (an example of a button 352 is indicated): move the corral, feed corralled animals, deliver a shock, access a camera inside the corral, and look at a dashboard of data related to the corral's operation. The settings icons 360 next to the action buttons lead to five interactive screens: the movement screen 370 where the user can change the movement parameters; the feed screen 380 where the user can change feed parameters, also using a slider 390; an electric fence screen 400 where the user can manipulate settings related to the electric fence; a live video screen 410 where the user can watch the corralled animals in real time and take pictures or record video; and dashboard 420 which displays information related to the state of the corral. The wireless communication protocol can be Bluetooth or any other workable protocol, or can be internet based, where the autonomous corral could be part of the Internet of things (IoT).

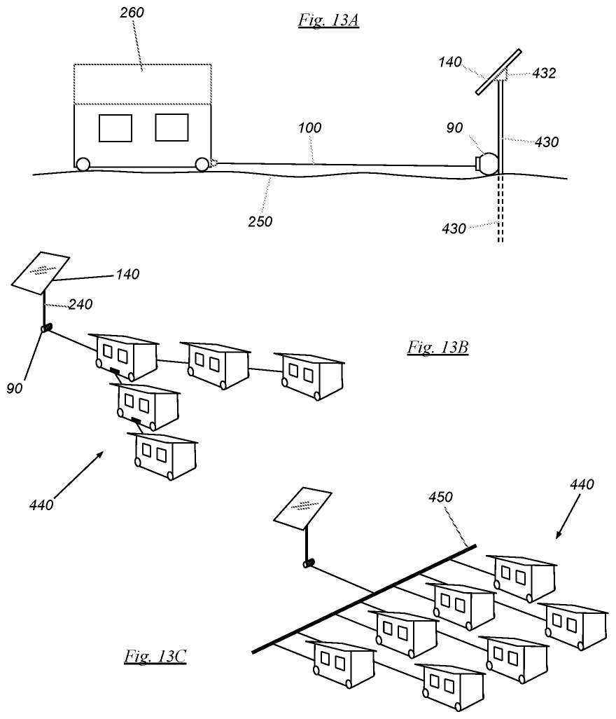

A variation of the preferred embodiment of the present invention is shown in FIG. 13A where the actuated winch 90 is connected to a post 430 anchored to the ground 250 instead of being mounted directly on the animal containment structure. The winched cable 100 is thus hooked to the animal containment structure instead of to the post 240. In its preferred embodiment the assembly also comprises a solar panel 140 and an electronics control unit/microcontroller 230. The panel 140 powers the electronics unit 432 and the winch 90 to pull the containment structure against the anchoring force provided by the post 430 and the ground 250. The post 430 or similar bracing structure could be anchored by any of a number of different methods, from driving or drilling it into the ground, much like a Pull Pal anchor for winching off-road vehicles out of ditches, to mounting it to a structure. The bracing structure could be movable or permanently mounted. The advantage of this variation of the embodiment is that it does not require the construction of an animal containment device and rather can be coupled with pre-existing mobile animal shelters to make them self-propelled.

Another advantage with the system shown in FIG. 13A is that it could be used to pull a fleet 440 of corrals at the same time, as shown in FIGS. 13B and 13C. In FIG. 13B the corrals are connected to each other in such a way, for example rigidly, that they each move along their own separate strip of grass so they do not go over areas that have already been covered by other corrals. In FIG. 13C the corrals are each connected to a central pull bar 450 or similar structure.

The illustrations simply show the concept of moving a fleet of corrals. The specific mechanics of how to do this can vary, but is straightforward for anyone skilled in the art of farming. It would also be possible to daisy-chain autonomous corrals.

Some of the design choices, which are results of prolonged prototyping and testing, warrant particular attention as they are instrumental in providing the most commercially viable product, and are discussed below.

### Capacitors

Capacitors store their energy as electric fields rather than in chemicals and therefore can be recharged over and over again and do not lose their ability to hold a charge like batteries do. So capacitors have a much longer lifespan than batteries, and batteries often reach early end of life in extreme weather conditions, which are a natural part of farming. While capacitors have lower energy density than batteries and therefore would take up more space for the same amount of energy, they have much greater power density. In other words they can discharge power faster than batteries which provide more constant power and are therefore ideal for situations where a burst of energy for a short time is needed, like shocking a predator or moving a corral a short distance. Similarly, unlike batteries capacitors recharge quickly, and this is important for maintaining the fence-shocking deterrent against predators. Therefore, they can still be made very small for the current application since energy is only ever needed in bursts. Capacitors are also less temperature sensitive than batteries and have a much broader range of operating temperatures, which is important in an application such as the one in question where weather can vary greatly. Also, the materials used to make capacitors are usually less toxic and do not cause the same toxic waste disposal problems as batteries do. The downsides to capacitors, such as lower energy density and self-discharge, making them poor for long term storage, are not relevant to the application in question since long term storage isn't the goal. The current application requires rapid discharges and recharges of energy and frequent cycling through high and low states of energy rather than long term storage.

Another advantage of capacitors is that sloshing energy between capacitors, for example for the purpose of boosting power as necessary, for instance to the electric fence, is more energy efficient than doing continuous direct current (DC) to direct current conversion. The problem with DC-to-DC conversion is that the converter is using power whenever it's running. When transferring power between two capacitors for example, conversion is required only once for the intended purpose and puts no ongoing strain on the energy budget.

### Locomotion

Most self-moving corrals from the prior art use driven wheels to cause forward motion. The problem with this is that driven wheels are not robust against varied terrain. Because corrals have to stay very low to the ground to keep predators out, since the corrals do not have floors, it can be difficult for the wheels to get proper traction and in many cases the corral can end up high-centered, where the wheels lose ground contact and the corral becomes immobilized. Another problem with the current wheeled solutions is that they are generally bi-directional; it is very hard to move the corrals other than forward or backwards. Sideways motion is very difficult or impossible, but sideways motion is often necessary if the corral gets stuck, where the user will need to pull or rock the corral sideways to unstick it or to change its direction.

The current invention addresses the problems of the corral high-centering or getting stuck by using either of two superior locomotion schemes. The first employs a motorized winch (the winch could also be manual), a pull-cable system for pulling the corral. In its simplest use the winch would be attached either to a remote stationary anchor like a fence post or similar structure and the cable ending would be attached to the corral, or a fleet of corrals, or the winch would be attached to the corral itself, with the cable ending attached to the remote stationary anchor. With sufficient cable and actuator strength, such winch systems can provide massive pull force such that a winched corral would in practice never get stuck. This scheme also has the advantage that the corral can always stay close to the ground, and in certain implementations does not even need wheels; skis or rounded cups may do, so the corral simply slides along as the winch pulls it.

The second locomotion scheme is centered around an unconventional gait which relies on non-radially symmetric elements which unlike radially symmetric wheels can provide a combination of lift and translational force. This combination of vertical and horizontal force empirically allows the corral to negotiate difficult and uneven terrain and avoid getting stuck. In the simplest implementation the asymmetric elements are positioned at the front of the corral and when activated rotate, causing the front of the corral to lift up slightly and then fall forward, somewhat like a paddle stroke or dry land version of a butterfly stroke in swimming. It turns out that this form of gait is substantially more robust than regular wheels when moving animal corrals which need to stay close to the ground. The price for the robustness is that the corral has to lift up slightly every time it takes a stroke forward. Another feature of this gait is that it moves the corral forward in cyclical steps, much like walking, rather than continuous rolling like with wheels. Thus, the corral may be operated to only move one stroke at a time since it does not need to displace itself at a faster rate in order to provide fresh pasture ground at a sufficient rate. This is advantageous as the corral will only be exposed for a brief movement every so often.

### Watering System

It is vital for corralled animals to have access to water. To avoid having to make regular trips into the field to replenish corral water supply, which would defeat part of the purpose of a self-moving corral, the current invention includes a rainwater collection system. This system comprises three parts, a collection surface, a drainage/gutter system, and a storage tank which is supplied by the drainage system.

### Feeding System

There is a substantial amount of prior art in animal feeding systems, including capacitively driven systems, as taught by Laceky in U.S. Pat. No. 7,275,501B1. The current invention uses a similar scheme, where feed is dispensed to corralled animals in spurts. These spurts can either be fixed amounts of feed, or a fixed dispensing period, such as a few seconds. This type of discrete or rationed dispensing is necessary for raising for example meat birds, like broiler chickens, as they might eat themselves to death if given free access to feed. The feed system can be passive for egg birds which are not at the risk of overeating. However, an active feeding system could have merit also in the case of egg birds as it could be used to control feed so as to regulate the birds' diets, for example pushing them to eat more grass and bugs by restricting access to feed.

### Non-Maiming Methods

Perhaps the most important consideration when designing a self-moving corral is making sure animals are not injured during movement of the corral. One way to keep the animals safe during motion is to make sure the corral moves in such a way that its moving walls, in particular the back wall, are not a danger to the animals. This can be achieved by moving the corral so slowly that animals cannot get entangled or injured. It can also be achieved by moving the corral by such a small amount, not larger than the size of an animal, that it does not pose a danger. Another successfully tested method is to use a compliant member at the back of the corral that either flexes or deflects if it comes into contact with an animal during motion. A further method is to use an element designed not to injure animals but to “persuade” or “induce” them to move forward as the corral moves, keeping them safe from getting entangled with moving walls. A fifth method is to dispense feed in conjunction with movement such that animals are drawn toward the feed and away from moving walls.

### Mobile Shocking

Other than physically preventing predator access by using enclosures and other separators, a mature technology is using electric fences which administer shocks designed to scare predators or cause sufficient discomfort to deter further predation attempts. Traditionally electric fencing and containment systems are stationary and can therefore have a solid electrical connection to ground, providing more electrical stability and max potential difference for greater shock value. Easily movable electric fence systems exist, but they are not the same as truly mobile ambulatory systems as would be needed on a self-moving animal corral. One solution is simply to provide a large amount of slack such that the fence can still be grounded permanently in one spot while still move with the moving corral. This is however impractical and introduces unnecessary cost, complexity, and even safety hazards. The better solution is to have the shocking system mounted to the corral without any tether to a stationary spot in the ground. In this case that works well: because the corral has to remain very low to the ground as part of the predator defense scheme, it also has good ground contact, and so the corral itself can function well as the grounding structure, approximating actual earth ground.

### Voltage and Power Levels

A key feature of the current invention is the integration of many different power levels onto a single circuit board. The reason this is important is because when there are multiple electrical events going on at different power levels, for example moving a winch motor or providing electrical shocks to predators, it is very easy to get electrical interference. A fence shocker for example could disrupt other electrical operations, so integrating electronic controls onto a single board allows for design and testing to avoid electrical interference across subsystems.

### Favorable Interplay of Design Features and Requirements

The following is an example of the favorable interplay of elements with this invention. The corral has to be low to the ground in order to keep out predators. But this minimal ground clearance makes the corral harder to move and more likely to get stuck. Therefore, traditional wheeled locomotion schemes are inferior to schemes which require more torque, and therefore more power. Capacitors are ideal for this situation as they can provide substantial power for short bursts, what is needed for the types of locomotion schemes taught in this disclosure. Short bursts are also ideal for providing shocks to predators. And the shocking system requires a connection to ground, which is achieved precisely by a corral which sits in close contact with the ground. Thus, the energy storage system, the locomotion scheme, the predator protection schemes, both small ground clearance, and active electric shocking scheme, and even the feed dispensing scheme, which requires short bursts (for meat birds), all fit together well. In essence the system features require energy in short bursts, which is ideal for lightweight capacitors, which also have the advantage of never wearing out. What is particularly relevant in this case is the ability to move very heavy corrals from the high-power density capacitors. In order to not defeat the purpose of a self-moving corral, it is necessary to load the corral up with ample feed and water so regular trips out to the corral are not necessary—if one first has to deliver water and feed, one might as well move the corral when on the spot. This loading makes the corral heavy, making it hard to move manually, necessitating substantial force to effect motion. Substantial force requires large energy bursts, exactly what electrical storage devices such as capacitors can deliver.

### Graphical User Interface

The automated corral can be wirelessly controlled through an application program running on a digital device such as a cellphone, tablet or personal computer. The graphical user interface (GUI) would allow the user to move the corral, dispense feed, provide shocks/energy to the electric fence, and engage a water heater to keep water from freezing, to name a few. The user interface provides a dashboard to allow a user to check on the status of the capacitor voltage/charge level, water level, water temperature, feed level, solar panel output, location, number of moves made during a certain period, or lifetime number of moves, or how far the corral has moved in a given period or over its lifetime. The interface would also let the user adjust settings, for example the number of scheduled moves per day, how far to move, move speed, how much torque to apply, how much feed to dispense, how long to feed, how much voltage to apply to each shock, how many shocks to administer per second, etc. The interface also allows visual inspection of the corral by accessing an internal camera showing live footage from inside the corral.

### Practical Discoveries

The prototyping process revealed a number of optimizations. Firstly, it became clear that it was often necessary to boost voltage to achieve a proper shock when using a capacitive energy storage system. Another related feature was employing an auto-shutoff of the electric fencing when the system detects a user carrying the appropriate electronics, like a fob device or a digital device with the appropriate software or settings, approaching the corral to interact with it manually. Another innovation was the discovery that water dispensing nipples are necessary at different heights to accommodate animals of different sizes. From operating the prototypes it also became obvious that it was necessary to install a drain valve at the lowest point in the water storage device in order to drain accumulated gunk in the system. Further, the corral should remain stationary at night such that the animals are not affected by a moving corral when sleeping. In one instance a malfunction caused the prototype to move at night leaving the sleeping animals exposed. Making sure the corral only moves during the day can be achieved by using the solar panel not simply as an energy collection device, but also as a photo sensor to gauge onset of dusk and dawn. It is also possible to upload annual daylight information based on geolocation and key the corral movement accordingly. Another substantial discovery was that corrals can be operated as a fleet when tethering them to a sufficiently powerful winch, allowing for scaling of husbandry operations. And in this regard, it was also discovered that replacing standard winch cables with smaller, but sufficiently strong, versions, makes it possible to wrap more cable and thus cover greater distances, reducing the need to change the position of the winch as often—something which must be done every time the cable reaches the end of its travel.

Another advantage of the current system which can recharge quickly is that it can be used adaptively. In other words, the system can be operated based on opportunity rather than time. For example, in situations where there is ample sunlight and therefore energy supply, more energy could be deployed to various functions such as moving, heating water, feeding, raising the voltage on the electric fence, because the energy storage system will quickly be replenished. This can be done autonomously, based on intelligent monitoring of energy and power, where settings are automatically adjusted to dynamically optimize for available energy. For example, the Al might regularly check the energy storage level and if the capacitors are fully charged, then use the unstorable excess energy arriving from the solar panels to perform tasks or maintenance routines which require energy.

The present invention has been described above in terms of a presently preferred embodiment so that an understanding of the present invention can be conveyed. However, many alternative ways of constructing the system are possible without departing from the principle of the invention. The scope of the present invention should therefore not be limited by the embodiments illustrated, but rather it should be understood that the present invention has wide applicability with respect to its stated objectives. For example, the present invention extends to any animal that might fit with this situation, for example rabbits, or on a larger scale, livestock. All modifications, variations, or equivalent elements and implementations should therefore be considered within the scope of the invention.

What is claimed is:

1. A system for moving a containment assembly, comprising:
a containment assembly;
an energy storage unit;
an energy collection unit;
a movement assembly for moving said containment assembly; and
an electronics control unit for managing the operation of the system.

2. The system of claim 1, said movement assembly including a cable for pulling the containment assembly.

3. The system of claim 1, said movement assembly including a radially asymmetric rotating element for lifting said containment assembly vertically while providing forward horizontal motion of the containment assembly.

4. The system of claim 1, further comprising a maiming prevention system to prevent the maiming of an animal in the containment assembly.

5. The system of claim 4, the maiming prevention system including moving said containment assembly slowly enough to not injure animals during movement.

6. The system of claim 4, the maiming prevention system including moving the containment assembly in increments so as to not injure animals during movement.

7. The system of claim 4, the maiming prevention system including a deflection element which yields if in contact with animals during motion of containment assembly so as to not injure animals.

8. The system of claim 4, the maiming prevention system including an element which induces/persuades animals to move forward with the movement of the containment assembly.

9. The system of claim 4, the maiming prevention system includes dispensing feed towards the front of the animal containment device such that the animals move towards the front of the device and are not injured by the back of the containment device during movement.

10. The system of claim 1, further comprising a water system, including a water collector, a water storage, and a water dispenser.

11. The system of claim 10, the water system further including a sensor for sensing water level in the water storage.

12. The system of claim 10, the water system further including a heater for keeping water in liquid state.

13. The system of claim 10, The system of claim 1, the water dispenser including multiple outlets arranged at different heights to accommodate different size animals.

14. The system of claim 10, the water system further including a cleanout system.

15. The system of claim 1, further comprising a feeding system, including a feed storage and a feed dispenser.

16. The system of claim 15, the feeding system including a sensor for sensing feed level in the feed storage.

17. The system of claim 15, wherein feed is automatically dispensed over a time period or in in a certain amount.

19. The system of claim 1, further comprising an animal protection system.

20. The system of claim 19, the animal protection system including an electric shocker.

21. The system of claim 20, wherein the energy storage unit has at least two elements, the energy of the first element being intermittently transferred to the second element using an inductor to achieve a higher voltage potential in the second element before energizing an electrical coil to produce the shock.

22. The system of claim 19, the animal protection system using the containment assembly as electrical ground.

23. The system of claim 19, wherein the animal protection system is powered down when it detects a user in proximity of the system.

24. The system of claim 1, further comprising a wireless communication device.

25. The system of claim 24, wherein the wireless communication device can be used to interact with the system from a digital device such as a smartphone or a computer, also through onboard sensors or a camera.
